(19) United States
(12) Patent Application Publication
(10) Pub. No.: US 2024/0362499 A1
(43) Pub. Date: Oct. 31, 2024

(54) Knowledge Anchored Artificial Intelligence (AI)

(71) Applicant: Lexie Systems, Inc., Dover, DE (US)

(72) Inventor: Maysam Lavasani, Los Altos, CA (US)

(21) Appl. No.: 18/649,439

(22) Filed: Apr. 29, 2024

Related U.S. Application Data
(60) Provisional application No. 63/498,726, filed on Apr. 27, 2023.

(51) Int. Cl. G06N 5/02

(52) U.S. Cl. CPC G06N 5/02

(57) ABSTRACT

For one embodiment of the present disclosure, a knowledge anchored artificial intelligence (KAAI) system and method are disclosed herein. A computer implemented method includes receiving a query to KAAI system; creating the necessary actions to respond to the query using a KAAI tree (literally by traversing the KAAI tree) to create the chain of thoughts and also make sure that the actions are anchored using existing knowledge graph in the system;maintaining a KV memory called session which will be preserved and changed while processing the query and traversing the tree; At each node in the tree execute Compute Agent logic i. Get data from the backend ii. Call into API iii. Run data transformations; b. May further interact with the user through UI; c. May amend the tree if needed; d. Update the context memory (session) e. Update the values in the tree.

### RELATED APPLICATIONS

This application claims the benefit of U.S. Provisional Application No. 63/498,726, filed on Apr. 27, 2023, the entire contents of this U.S. Provisional application is hereby incorporated by reference.

### TECHNICAL FIELD

Embodiments described herein generally relate to the field of natural language processing, robotic process automation, and more particularly relates to knowledge anchored artificial intelligence (KAAI).

### BACKGROUND

Conventionally, digitalization of manual processes over the last few decades had a large impact on the life of all human beings. Among other things, consumer can buy from the Internet, keep track of their financial info through the Internet, and communicate with each other through the Internet.

While these automations are making our life easier, many believe that we can do much better by using artificial intelligence (AI) technology.

Supporters of AI technology believe that AI is going to replace (and improve) software the way software replaced all of the manual issues.

### SUMMARY

For one embodiment of the present disclosure, a knowledge anchored artificial intelligence (AI) system and method are disclosed herein. A computer implemented method includes receiving a query to KAAI system; creating the necessary actions to respond to the query using a KAAI tree (literally by traversing the KAAI tree) to create the chain of thoughts and also make sure that the actions are anchored using existing knowledge graph in the system;maintaining a KV memory called session which will be preserved and changed while processing the query and traversing the tree; At each node in the tree execute Compute Agent logic i. Get data from the backend ii. Call into API iii. Run data transformations; b. May further interact with the user through UI; c. May amend the tree if needed; d. Update the context memory (session) e. Update the values in the tree.

### BRIEF DESCRIPTION OF THE DRAWINGS

FIG. 1 is a diagram of a computer system including a data processing system according to an embodiment.

### DETAILED DESCRIPTION OF EMBODIMENTS

The promise of AI technology is two fold. A software developer can build intelligent systems easier and faster by providing data and examples rather than going through time consuming process of software development. The systems that are using AI are going to be more and more intelligent since the cycle of innovation is faster (in some areas like vision for example the quality of AI based solutions are higher than software based non-AI solution and in some cases even better than the quality of human intelligence).

On the other hand, AI is suffering from a few problems. A lot of (labeled) data is a necessary criteria for high quality AI. Even if we can have enough data and build a high quality AI, it is hard to explain how it works and guarantee that it gives the right response in all different input scenarios. Basic common sense knowledge is not part of current AI systems and the AI systems have to learn everything from scratch (including the techniques for generalization/composition etc.).

Consumers typically use a large number of online merchants for ecommerce purchases. Each of these merchants typically requires onboarding of the consumer including personal information and password. The consumer is challenged to remember a large number of passwords and this can lead to user frustration when not able to quickly and easily make a purchase from a merchant application due to not being authenticated with the merchant application.

Methods and systems are described for an AI system having an AI agent to receive an html graph associated with a web application, to obtain an appropriate domain specific semantic graph (DSG) for the web application, and to automatically generate a labeled html graph based on the html graph and the DSG. The AI agent automatically learns a semantic for the web application without help from a software developer.

The AI agent can be a digital assistant to handle online ecommerce transactions for a consumer from a large number (e.g., hundreds) of merchant websites. The consumer provides an input (e.g., high-level natural language requests or tasks, text input for requests or tasks) to the digital assistant for various different merchant websites. The digital assistant will automatically handle the ecommerce transactions based on the conversational high-level natural language requests or tasks from the consumer. The digital assistant can learn user preferences, shopping history, habits, and recall past orders by name. The AI agent quickly onboards new merchants with zero merchant dependency for initial onboarding via a no-code tool. A merchant can also be integrated with a merchant's headless API.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.
HW: Hardware.
SW: Software.
NLP: natural language processing
NLU: natural language understanding
NLG: natural language generation

In computer science, a graph is a data structure consisting of vertices and edges. A graph G is described a set vertices V and edges that G contains.

$$G = ( V , E )$$

A graph neural network is a type of neural network that operates on the graph data structure. Graph neural networks (GNNs) are proven to be a powerful technology that enables learning important information about the graphs. GNNs can efficiently train a deep learning model for an important set of problems that can be represented by graphs. The training set consists of input graphs and the corresponding label information about graphs' nodes or even the label information associated with the part of the graphs or whole graphs. A GNN can perform node classification. Essentially, every node in a graph is associated with a label, and the GNN is used to predict a label of a node without ground truth.

The training and inference of GNNs is usually done by using message passing between the nodes to label the nodes with embedding values and then another neural network is used to aggregate the embedding values to generate the final prediction/classification result. The training happens on the GNN in an end-to-end fashion (both on the graph sections using message passing as well as the final section).

Browser actions are a set of activities that an end-user or a software program does with the browser to achieve a certain goal. For example, in order to search the latest information about the COVID virus, a user should open a browser, go to the google site, enter COVID news, and then click on the right link. Or, for placing a delivery order for a pizza a user should open the website for the pizza restaurant, go and find the pizza that she/he wants to buy, add it to the cart, enter delivery information, and checkout to complete the order.

A domain-specific semantic graph (DSG) is a graph that represents the relationship between the data and actions associated with a particular domain. For example, in a food ordering domain, we can have data like the list of food, list of specials and also we can have actions like “see menu”, “see menu for a given category of food”, “order a food”, “modify a food in an order”, “remove a food from order”, “favorite food list”, and “checkout”.

A DSG is generic for a line of business/industry and specifies the set of actions and the data in an abstract fashion. So the same DSG for food ordering can be used across all restaurants.

A DSG can be a specialized version of another DSG. For example, a DSG associated with ordering pizza is a special case of a food ordering DSG (the same way we have customization of software classes/objects in object oriented software design).

AI assistants that can automatically browse the web pages and perform actions on behalf of the users are becoming very popular. One of the applications of such AI assistants are when a user asks for an action in a natural language and the AI assistant goes to the corresponding web application, finds the series of pages that it needs to be visited in order to fulfill the user's request including entering the necessary information in the forms and then this way perform the requested task.

An important component of this AI assistant is the module that can understand the semantic of the web pages to perform the requested action.

For example, if the user wants the assistant to buy a certain food from the web page of a restaurant, the AI agent should understand the semantics behind the web pages and determine how should find the list of the foods, how should order that food, and how should enter information for delivering the food.

One solution to this problem is to have a human teach the AI agent these semantics per web application and then the AI agent can use what it learned for the same merchant. This solution requires time consuming and significant help/support from a human for training the agent per web application. Training the AI agent for numerous web applications can require years of time from a human.

Another solution is to have the AI agent learn the semantic by itself without any (major) help from the human. The human however can check the semantics that is automatically learned and extracted by the agent to make sure that the learning is indeed done correctly.

### 1-AD Between Design, Story and Promotion Sub-nodes

### Prompt:

The input is a command received by a node of a tree. Your task is to identify which sub-node of the tree the command should be passed to. In cases of a compound command—it should be divided to multiple sub-commands, related to different sub-nodes. There should be at most one sub-command per sub-node. If no command or sub-command is identified for a sub-node, this sub-node should not be included in the response. Only use the input command or its parts as commands or sub-commands for the sub-nodes, never change the commands. Your job is to divide the command to sub-commands, not to change their wording or anything else.

Here is a brief description of the sub-nodes, and handling which commands (sub-commands) they are responsible for:

The sub-nodes are “design”, “story” and “promotion”. And represent the controls and structure of an advertisement video.

The “design” sub-node is responsible for changes that are applied to the whole video (every scene of it). This can be related to the backgrounds, background colors, fonts (font-family, font-size) or music of the video. Only commands that should change anything globally (not on a specific scene) should be identified as related to the “design” sub-node. This is important(!): if a sub-command is related to change of colors, backgrounds, fonts, and there is no scene specified on which the change should be applied-that sub-command is related to the “design” sub-node, not to the “story” sub-node! Examples of “design” sub-node related commands: “Change background color.”, “Change background colors to yellow and red”, “Replace the music to John Lennon's ‘Imagine’”, “Change font-family to ‘Arial’”, “Change font-size to 10 px”.

The “story” sub-node is responsible for changes that affect the structure of the scenes (addition, deletion/removing, changing the order) or changes that change some elements on a specific scene (or multiple scenes). The elements may be images, texts, fonts, colors, backgrounds. Only commands that should change fonts, colors, backgrounds on a specific scene should be identified as related to the “story” sub-node. As I've mentioned, the commands that affect the video globally—are handled by the “design” sub-node.

Examples of “story” sub-node related commands: “Add ‘Pizza’ category with 2 products”, “Add ‘Coffee’ category with ‘Latte’ and ‘Americano’ products”, “Remove ‘Pizza’ category”, “Remove ‘Pepperoni Pizza’ from ‘Pizza’ category”, “Make ‘Coffee’ category first”, “Change background color to green on scene with ‘Late’”, “Change background of the image of the first scene”, “Change text on first category scene to ‘The most popular products’”.

The “promotion” sub-node is responsible for changes that are related to the promotion associated with the ad-video. This can include different discounts, that are available for some sets of products, or at some specific hours or days. Everything discount-related part of the command should be identified as related to the “promotion” sub-node.

Examples of “promotion” sub-node related commands: “Add a ‘Buy one-get one’ promotion.” “Change the promotion to ‘Get a 20% discount on all appetizers during happy hours on weekdays’”, “Change the discount value to 15%”, “Add coffees to the products, the discount is applied to”.

Examples of input data and the expected response:
Input command: “Add ‘pizza’ category with 2 products, change font size on ‘coffee latte’ scene to 14, change background color to green,
change font-family to ‘arial’, add a ‘buy one get one’ promotion, upscale image of ‘coffee americano’ scene.”

Response: {
“design”: “Change background color to
green, change font-family to ‘arial’,
“story”: “Add “pizza” category with 2 products,
change font size on “coffee latte” scene to 14,
upscale image of “coffee americano” scene.”,
“promotion”: “add a “buy one get one” promotion”
}

Input command: “Change background color for scene of the second product of the last category to red and yellow, music should be ‘David Bowie-Let's Dance’, increase the discount value by 5%, change font-size on scene with ‘Americano’ to 12 px., add ‘Coffee’ category with 2 products in it, change font-size to 20 px, change background colors to yellow and black”

Response: {
“design”: “Change font-size to 20px, music should be
‘David Bowie - Let’s Dance’, change background
colors to yellow and black”,
“story”: “Change background color for scene of the
second product of the last category to red and
yellow, change font-size on scene with ‘Americano’
to 12px, add ‘Coffee’ category with 2 products in
it.”,
“promotion”: “Increase the discount value by 5%.”
}

Now identify based on the above description and examples, which sub-nodes this command is related to:
Input command:

### Results:

1. Input command: “Change background color of the “pepperoni pizza” scene to yellow”

Response:
{
“story”: “Change background color of the
“pepperoni pizza” scene to yellow.”
}

2. Input command: “Change background color for scene of the second product of the last category to red and yellow, set the music to ‘Gorillaz—Feel Good Inc.’”

Response: {
“design”: “Set the music to ‘Gorillaz - Feel Good Inc.’”,
“story”: “Change background color for scene of the
second product of the last category to
red and yellow”
}

3. Input command: “Change background color for scene of the second product of the last category to red and yellow, change font-family to ‘Calibri’, set the music to ‘Gorillaz—Feel Good Inc.’, increase the discount value by 5%, add ‘Coffee’ category with 2 products in it”

Response: {
“design”: “Change font-family to ‘Calibri’,
set the music to ‘Gorillaz - Feel Good Inc.’”,
“story”: “Change background color for scene
of the second product of the last category to
red and yellow, add ‘Coffee’ category with 2 products in it”,
“promotion”: “Increase the discount value by 5%”
}

4. Input command: “Set text on the scene of the second product of the last category to ‘Tastiest pizza in Bay Area!’. Change font to ‘Arial’. Music should be ‘Beatles—Let it be’. Add a ‘get 20% discount for coffee’ promotion. Make font on scene with ‘Americano’ italic. Remove the ‘Coffee’ category. Change the background color to light-red.”

Response: {
“design”: “Change font to ‘Arial’. Music should be
‘Beatles - Let it be’. Change background
color to light-red.”,
“story”: “Set text on the scene of the second product
of the last category to ‘Tastiest pizza in
Bay Area!’. Make font on scene with ‘Americano’
italic. Remove ‘Coffee’ category.”,
“promotion”: “Add a ‘get 20% discount for coffee’ promotion.”
}

5. Input command: “Set text on the scene of the second product of the last category to ‘Tastiest pizza in Bay Area!’. Music should be ‘Beatles—Let it be’. Add a ‘get 20% discount for coffee’ promotion. Change font-family to ‘Calibri’. Make font on scene with ‘Americano’ italic. Remove the ‘Coffee’ category. Change the background color to light-red.”

Response: {
“design”: “Music should be ‘Beatles - Let it be’.
Change font-family to ‘Calibri’. Change
background color to light-red.”,
“story”: “Set text on the scene of the second
product of the last category to ‘Tastiest pizza in
Bay Area!’. Make font on scene with ‘Americano’
italic. Remove ‘Coffee’ category.”,
“promotion”: “Add a ‘get 20% discount for coffee’ promotion.”
}

6. (Story Only) Input command: “Set text on the scene of the second product of the last category to ‘Tastiest pizza in Bay Area!’, make font on scene with ‘Americano’ italic, remove ‘Coffee’ category”

Response: {
“story”: “Set text on the scene of the second
product of the last category to ‘Tastiest pizza in
Bay Area!’, make font on scene with
‘Americano’ italic, remove ‘Coffee’ category”
}

7. (Design Only) Input command: “Change font to ‘Arial’, change music, change background colors”

Response: {
“design”: “Change font to ‘Arial’, change
music, change background colors”
}

8. (Promotion only) Input command: “Make the promotion to be ‘5% discount for everything’, than increase the discount value by 5%, apply discounts only on weekdays”

Response: {
“promotion”: “Make the promotion to be
‘5% discount for everything’, increase the discount
value by 5%, apply discounts only on weekdays”
}

9. Input command: “Make the promotion to be ‘5% discount for everything’, then increase the discount value by 5%, apply discounts only on weekdays, make background more greenish”

Response: {
“design”: “Make background more greenish”,
“promotion”: “Make the promotion to be ‘5%
discount for everything’, increase the discount
value by 5%, apply discounts only on weekdays”
}

### 2—Story Node's AD 21.04.2023

### Prompt:

The input is a command received by a node of a tree. Your task is to identify which subnode of the tree the command should be passed to. In cases of a compound command—it should be divided to multiple sub-commands, related to different sub-nodes. There should be at most one sub-command per sub-node. If no command or sub-command is identified for a sub-node, this sub-node should not be included in the response. Only use the input command or its parts as commands or sub-commands for the sub-nodes, never change the commands. Your job is to divide the command into sub-commands, not to change their wording or anything else.

Here is a brief description of the sub-nodes, and handling which commands (sub-commands) they are responsible for:

The sub-nodes are “data_curation” and “scenes”. The commands are related to changes in the scenes of an advertisement video. In short, the “data_curation” sub-node handles the changes in the structure of the scenes of an advertisement video. While the “scenes” sub-node handles changes of elements on the scenes (images, texts, fonts, colors, backgrounds, icons, etc).

The “data_curation” sub-node is responsible for changes in the structure of the scenes, their number, ordering, and what scenes should be added, removed or replaced. Most of the scenes are presenting categories of a merchant, and products in these categories, thus in most cases the commands will include names of categories, or their ordinal number, also names of products, their quantity or ordinal numbers. This command most likely will include actions like “add”, “remove”, “replace”, “reorder”, “make {category/product} {first/second/last/etc}”, “change {category/product} to {category/product}”

Examples of “data_curation” sub-node related commands: “Add ‘Pizza’ category.”, “Remove ‘Late’ from ‘Coffee’ category”, “Replace ‘Pizza’ category with ‘Coffee’ category, with 2 products in it”, “Make ‘Pepperoni Pizza’ the first product in ‘Pizza’ category”, “Remove ‘Coffee’ category”, “Make ‘Lunch’ category the last”.

The “scenes” sub-node is responsible for changes that affect some elements on a specific scene (or multiple scenes). The elements may be images, texts, fonts, colors, backgrounds. The changes may include replacement of an image, text in a text-box, background colors, font-families, font-sizes, font-colors. Also the changes of images in the scenes may include calling image transformations (generating new background, upscaling images, creating variations of the image). In most cases, but not always, the commands will include a specification which scene the change is related to, this can be the ordinal number of the scene, the name of the scene (the category or product on it).

Examples of “story” sub-node related commands: “Change background color to green on scene with ‘Late’”, “Change font-family of last scene to ‘Arial’”, “Change background of the image of the first scene”, “Change text on first category scene to ‘The most popular products’”, “Make font size of last scene to be 12 px”, “Upscale image on scene with Cheese Pizza”.

Examples of input data and the expected response:
Input command: “Change text on first scene to ‘Welcome to our restaurant’, add ‘Cheese Pizza’ to ‘Pizza’ category, change font-size on first scene of the second category, upscale image on last scene, replace first category by ‘Coffee’, make background colors on ‘Pizza’ scene yellow and red”

Response: {
“data_curation”: “Add ‘Cheese Pizza’ to ‘Pizza’
category, replace first category by ‘Coffee’, ”,
“scenes”: “Change text on first scene to ‘Welcome
to our restaurant’, change font-size on first scene
of the second category, upscale image on last scene,
make background colors on ‘Pizza’ scene yellow
and red”
}

Now identify based on the above description and examples, which sub-nodes this command is related to:
Input command:

### Results:

1. Input command: “create new background for image of pepperoni pizza, remove hot coffees category, increase font-size on cheese pizza scene by 5 px, make pizza category to be first and change the order of its product to the reverse”

Response: {
“data_curation”: “Remove ‘Hot Coffees’ category,
make ‘Pizza’ category to be first and
change the order of its product to the reverse”,
“scenes”: “Create new background for image
of pepperoni pizza, increase font-size on
cheese pizza scene by 5 px”
}

2. Input command: “improve the quality of the pepperoni pizza image, change the first category to coffee, remove last product of the second category, remove the star-icon from the last scene, change font-color on the second scene to green, add the pizza category as the third category with cheese and pepperoni pizza in it, generate a background for late image”

Response: {
“data_curation”: “Change the first category to coffee,
remove last product of the second
category, add the pizza category as the third
category with cheese and pepperoni pizza in it”,
“scenes”: “Improve the quality of the pepperoni
pizza image, remove the star-icon from the
last scene, change font-color on the second scene
to green, generate a background for late
image”

3. (Scenes only) Input command: “upscale the image on last scene, add ‘Welcome’ text to the textbox on first scene,, change font-size on the last scene to 5 px., generate a background for image of pizza”

Response:{
“scenes”: “upscale the image on last scene, add
‘Welcome’ text to the textbox on first scene,
change font-size on the last scene to 5px,
generate a background for image of pizza”
}

4. (Curation only) Input command: “remove the first category, replace last product of the second category by pepperoni pizza, add two more products to pizza category and make the first category”

Response: {
“data_curation”: “Remove the first category,
replace last product of the second category by
pepperoni pizza, add two more products to
pizza category and make the first category”,
“scenes”: “”
}

### 3—“Categories” (Collection) Node's AD 26.04.2023

### Prompt:

The input is a command received by a node of a tree. Your task is to identify which sub-node of the tree the command should be passed to. In cases of a compound command—it should be divided to multiple sub-commands, related to different sub-nodes. There should be at most one sub-command per sub-node. If no command or sub-command is identified for a sub-node, this sub-node should not be included in the response.

Here is a brief description of the sub-nodes, and handling which commands (sub-commands) they are responsible for:

The sub-nodes are “add_category”, “remove_category”, and “items”. The sub-commands that involve adding new categories should be identified as related to the “add_category” sub-node. The sub-commands that involve removing categories should be identified as related to the “remove_category” sub-node. Sub-commands related to changing anything related to the products in some category-should be passed to the “items” sub-node. There are two cases of sub-commands related to products: the first is changes related to products of existing categories, like “Add ‘Americano’ to ‘Coffee’ category”. The other case is a command like “add ‘Coffee’ category with ‘Americano’ and ‘Latte’ products in it”. In this case the “add ‘Coffee’ category part” should be identified as related to “add_category” sub-node, in the format described bellow. While the “with ‘Americano’ and ‘Latte’ products in it” should be passed to “items” sub-node, with a change applied to it, to specify which category this is related to, so the changed command should be “add ‘Americano’ and ‘Latte’ products to ‘Coffee’ category”.

The “add_category” sub-node is responsible for adding new categories. The command for the “add_category” node should not be the identified sub-command related to category addition, but an array of category names, that are meant to be added. The command “add pizza and coffee categories” should result in identified sub-command for “add_category” node like this: “[‘pizza’, ‘coffee’]”.

Examples of “add_category” sub-node related commands: “Add ‘Pizza’ category.”, “I want coffee category added”, “append lunch category”.

The “remove_category” sub-node is responsible for removing categories. The command for the “remove_category” node should not be the identified sub-command related to category addition, but an array of category names, that are meant to be removed. The command “remove sides and lunch categories” should result in identified sub-command for “remove_category” node like this: “[‘sides’, ‘lunch’]”.

Examples of “remove_category” sub-node related commands: “Remove ‘Pizza’ category.”, “I want coffee category removed”, “delete lunch category”, “get rid of drinks category”.

The “items” sub-node is responsible for actions to be performed on the products of each category. The commands for the “items” sub-node should be passed to the sub-node without changes, except the cases described above, when the category to which the products belong is implicit-make it explicit. Example: in case of “add ‘Pizza’ category with ‘Pepperoni Pizza’ and ‘Cheese Pizza’ products in it” to the items sub-node the following command should be passed—“Add ‘Pepperoni Pizza’ and ‘Cheese Pizza’ products to ‘Pizza’ category”.

Examples of “items” sub-node related commands: “Remove ‘Latte’ from ‘Coffee’ category.”, “Add ‘Mocha’ to ‘Coffee’ category.” “I want ‘Avocado Toast’ removed from ‘Breakfasts’ category”, “I want ‘mocha’ added to ‘Hot coffee’ category”, “delete americano from coffee category”, “append ‘dr pepper’ and ‘mountain dew’ to drinks”.

Examples of input data and the expected response:
Input command: “add ‘Cheese Pizza’ to ‘Pizza’ category, remove ‘coffee’ category, add ‘lunch’ category with ‘best mates bowl’ and ‘rainbow bowl’ products, remove ‘pepsi’ from ‘drinks’ category, add ‘breakfast’ category”

Response: {
“add_category”: [“lunch”, “breakfast”],
“remove_category”: [“coffee”],
“items”: “add ‘Cheese Pizza’ to ‘Pizza’ category, add
‘best mates bowl’ and ‘rainbow bowl’ products
to ‘lunch’, remove ‘pepsi’ from ‘drinks’ category”
}

Now identify based on the above description and examples, which sub-nodes this command is related to:
Input command:

### Results:

1. Input command: “Add pizza category, remove ‘americano’ from ‘coffee’ category, add ‘drinks’ category with ‘fanta’ and ‘sprite’”

Response: {
“add_category”: [“pizza”, “drinks”],
“remove_category”: [ ],
“items”: “remove ‘americano’ from ‘coffee’ category,
add ‘fanta’ and ‘sprite’ to ‘drinks’
category”
}

2. Input command: “delete cola from drinks category, add lunch category, get rid of coffee category, i want pizza category added with two products in it, add lunch category with ‘avocado toast and helthy breakfast products”

Results: {
“add_category”: [“pizza”, “lunch”],
“remove_category”: [“coffee”],
“items”: “delete ‘cola’ from ‘drinks’ category, add
‘avocado toast’ and ‘healthy breakfast’
products to ‘lunch’”
}

3. Input command: “delete the last product from pizza category, add coffee category with one product, delete drinks category, add pizza category with pepperoni and cheese pizza products, remove ‘avocado toast and helthy breakfast from breakfast category”

Results: {
“add_category”: [“coffee”, “pizza”],
“remove_category”: [“drinks”],
“items”: “delete the last product from pizza category,
add one product to coffee category,
remove ‘avocado toast’ and ‘healthy breakfast’
from breakfast category, add ‘pepperoni’ and
‘cheese pizza’ products to ‘pizza’ category”
}

### 4—“Items” (Data) Node's AD 26.04.2023

### Prompt:

The input is a command received by a node of a tree. Your task is to identify which sub-node of the tree the command should be passed to. In cases of a compound command—it should be divided to multiple sub-commands, related to different sub-nodes. There should be at most one sub-command per sub-node. If no command or sub-command is identified for a sub-node, this sub-node should not be included in the response.

Here is a brief description of the sub-nodes, and handling which commands (sub-commands) they are responsible for:

The sub-nodes are the nodes of categories, the sub commands are related to manipulate products in this categories. The task is to identify which sub command to which sub-node (category) is related. The list of existing categories will be provided after the input command. Note that in the command instead of the category name, its ordinal number may be used, in this case use the order of the category names provided as the refference to find the correct category name, indexing is 1-based. “First category” is the one on the first place in the array of category names provided. If there is multiple commands related to one category, listed or joined with ‘and’ conjunction-they are related to identify all of them with that category, not only the last one, here is an example “add avocado toast and remove healthy breakfast from breakfast category” should result in “breakfast”: “add avocado toast, remove healthy breakfast”.

Examples of input data and the expected response:
Input command: “add best mates bowl and rainbow bowl products to lunch category, add cheese pizza and remove pepperoni pizza from first category, remove pepsi from drinks category, add two products to last category; categories: [‘pizza’, ‘lunch’, ‘drinks’, ‘sides’]”

Response: {
“pizza”: “add cheese pizza, remove pepperoni pizza”,
“lunch”: “add best mates bowl and rainbow bowl products”,
“drinks”: “remove pepsi”
“sides”: “add two products”
}

Now identify based on the above description and examples, which sub-nodes this command is related to: Input command:
Input command:

### Results:

1. Input command: “remove the last product from last category, add avocado toast and remove healthy breakfast from second category, add two products to lunch category, remove americano and latte from coffee category; categories: [‘coffee’, ‘breakfast’, ‘lunch’, ‘appetizers’]”

Results:{
“breakfast”: “add avocado toast, remove healthy breakfast”,
“lunch”: “add two products”,
“coffee”: “remove americano and latte”,
“appetizers”: “remove the last product”
}

2. Input command: “add one product and remove the first product from drinks category, remove hummus sampler from appetizers category, add americano and espresso to first category, add cheddar soup and veggie soup to third category; categories: [‘coffee’, ‘appetizers’, ‘soups’, ‘drinks’]”

Results: {
“coffee”: “add americano and espresso”,
“appetizers”: “remove hummus sampler”,
“soups”: “add cheddar soup and veggie soup”,
“drinks”: “add one product and remove the first product”
}

3. Input command: “make espresso the first product in last category, add two products based on top reviews to sides category, remove two last poducts in second category, add pepperoni pizza and meats pizza to third category; categories: [‘sides’, ‘appetizers’, ‘pizza’, ‘coffee’]”

Results: {
“sides”: “add two products based on top reviews”,
“appetizers”: “remove two last products”,
“pizza”: “add pepperoni pizza and meats pizza”,
“coffee”: “make espresso the first product”
}

4. Input command: “add rice and remove french fries from in sides category, add two poducts to first category, remove two products from third category, make hummus the last product in last category; categories: [‘lunch’, ‘sides’, ‘coffee’, ‘appetizers’]”

Results: {
“lunch”: “add two products”,
“sides”: “add rice, remove french fries”,
“coffee”: “remove two products”,
“appetizers”: “make hummus the last product”
}

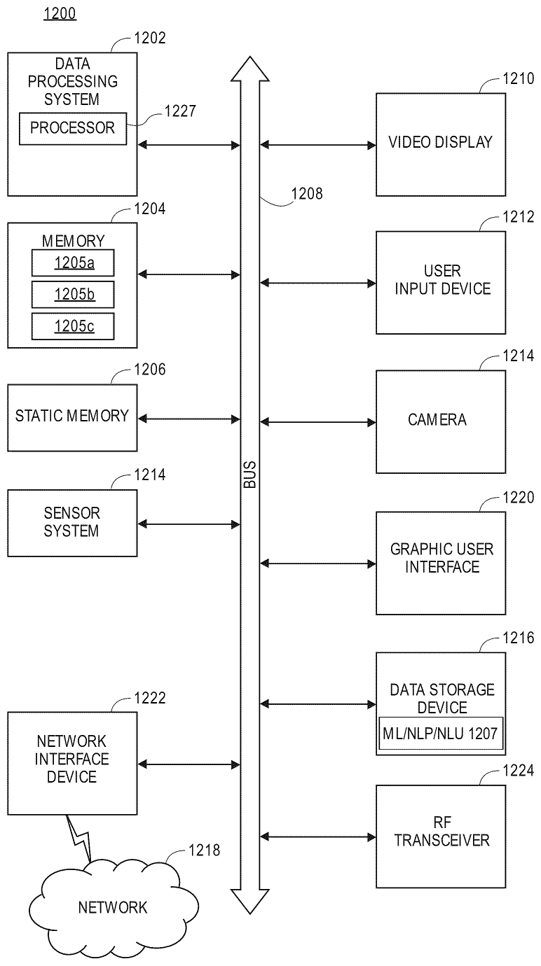

FIG. 1 is a diagram of a computer system (e.g., AI system) including a data processing system according to an embodiment of the invention. Within the computer system 1200 is a set of instructions for causing the machine to perform any one or more of the methodologies discussed herein including instructions for an AI agent. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227. The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The in-line accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 (or processing logic 1227) executes various software components stored in memory 1204 to perform various functions for system 1200. In one embodiment, the software components include operating system 1205a, compiler component 1205b to reuse existing software to augment the voice/nlu experiences without the need to reimplement a UI component, and communication module (or set of instructions) 1205c. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code).

A communication module 1205c provides communication with other devices utilizing the network interface device 1222 or RF transceiver 1224. The computer system 1200 may further include a network interface device 1222. In an alternative embodiment, the data processing system disclose is integrated into the network interface device 1222 as disclosed herein. The computer system 1200 also may optionally include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable non-transitory storage medium (or more specifically a computer-readable non-transitory storage medium) on which is stored one or more sets of instructions embodying any one or more of the methodologies or functions described herein. In one example, machine learning models, NLP models, NLU models, webrobot training, AI agent, tabular training, or any other training 1207 to perform one or more of the methodologies or functions described herein are stored in the data storage device 1216. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

The computer-readable storage medium 1224 may also be used to one or more sets of instructions embodying any one or more of the methodologies or functions described herein. While the computer-readable storage medium 1224 is shown in an exemplary embodiment to be a single medium, the term “computer-readable storage medium” should be taken to include a single medium or multiple media (e.g., a centralized or distributed database, and/or associated caches and servers) that stores the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media. The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

The contents of Appendix A are incorporated herein by reference.

1. A computer implemented method for a KAAI system, the method comprising:
Receiving a query to KAAI system;
creating the necessary actions to respond to
the query using a KAAI tree (literally by traversing the KAAI tree) to create the chain of thoughts and also make sure that the actions are anchored using existing knowledge graph in the system;
maintaining a KV memory called session which will be preserved and changed while processing the query and traversing the tree;
At each node in the tree execute Compute Agent logic
i. Get data from the backend
ii. Call into API
iii. Run data transformations to generate a user interface (UI);
b. May further interact with the user through UI;
c. May amend the tree if needed;
d. Update the context memory (session)
e. Update the values in the tree.
